(19) United States
(12) Patent Application Publication
(10) Pub. No.: US 2010/0013334 A1
(43) Pub. Date: Jan. 21, 2010

(54) Starter

(76) Inventors: Hitoshi Ono, Gunma (JP); Tomohiko Ikemori, Gunma (JP); Hiroshi Ooka, Gunma (JP); Masaaki Oya, Gunma (JP)

Correspondence Address: WENDEROTH, LIND & PONACK, L.L.P., 1030 15th Street, N.W.,, Suite 400 East, Washington, DC, 20005-1503, US

(21) Appl. No.: 11/922,030

(22) PCT Filed: Jun. 22, 2006
(86) PCT No.: PCT/JP2006/312534

§ 371 Date: Sep. 15, 2009

(30) Foreign Application Priority Data
Jun. 23, 2005 (JP) 2005-183761

(51) Int. Cl. H02K 5/00

(52) U.S. Cl. 310/91

(57) ABSTRACT

In a starter having a motor comprising a rear bracket 23 mounted to a cylindrical motor housing opening portion, flanges 23a protruding outward from the outer circumferential portion 23c of the rear bracket and set bolts mounted to the flanges 23a and located on the outside of the motor housing, the rear bracket 23 is formed sphere-like with the inner side of the motor being convex and the central portion of the rear bracket is expanded toward the inner side of the motor compared with the outer circumferential portion 23c thereof. Even if the rear bracket 23 is subjected to impact due to “Kicking back”, the influence of the impact force is relaxed by the central portion displaced inward in advance and the rear bracket 23 is effectively prevented from being lifted up due to “Kicking back” in spite of an outer bolt type configuration.

### TECHNICAL FIELD

The present invention relates to a starter mounted to an engine of an automotive etc. and used for starting the engine, and more particularly, to a motor rear bracket structure of the starter rotary-driven by an electric motor.

### BACKGROUND ART

In engines used in cars, two-wheeled motor vehicles and large generators, a starting operation is generally performed by an electric starter mounted to an engine. FIG. 4 is an illustrative view showing the configuration of such a starter. In the starter 101 of FIG. 4, an electric starter motor 102 is used, and a pinion gear 103 is rotary-driven via a reduction gear mechanism (not shown) and an overrunning clutch (not shown). The pinion gear 103 is mounted movably in an axial direction, moved by a lever (not shown) in the axial direction and brought into engagement with a ring gear 104 of the engine.

In the starter motor 102 used in the starter 101, a rear bracket 106 and a front bracket 107 are mounted to the end portion of a yoke 105. FIG. 5 is an illustrative view showing a structure for mounting the rear bracket 106. As shown in FIG. 5, the rear bracket 106 is formed disk-like and is secured to the rear end (end portion further from the engine) of the cylindrical yoke 105 by means of set bolts 108. The set bolts 108 are located on the outer side of the yoke 105, and on the outer circumference of the rear bracket 106, there are provided flanges 109 to which the set bolts 108 are mounted. The set bolts 108 are mounted from the side of the flanges 9 and screwed into bolt holes (not shown) formed in the front bracket 107 to be secured.

A motor shaft 111 is supported rotatably by a bearing 112 in the central portion of the rear bracket 106. A commutator 113 and a wire-wound (not shown) stator core 114 are secured to the motor shaft 111, forming an armature 115 of the starter motor 102. A brush 116 is in slidable contact with the commutator 113 from a radial direction.
Patent Document 1: Jpn. Pat. Appln. Laid-Open Publication No. 2004-194375
Patent Document 2: Jpn. Pat. Appln. Laid-Open Publication No. 2002-130099

### DISCLOSURE OF THE INVENTION

### Problems to be Solved by the Invention

However, when starting an engine using such a starter 101, there may occur a so-called “Kicking back”-phenomenon (hereinafter, referred to as “Kicking back”), that is, a phenomenon in which the engine is rotated inversely as result of plug ignition before the upper dead center due to an off ignition timing. In such a situation, there is a problem that the impact thereof is transmitted to the side of the starter motor 102, applying reaction force to the rear bracket 106. In this case, the overrunning clutch is engaged with the pinion gear 103. Nevertheless, if the pinion gear 103 is rotated inversely, the inverse rotations are not interrupted by the clutch and are directly transmitted to the motor shaft 111. That is, the inverse torque is transmitted from the pinion gear 103 via the overrunning clutch and the reduction gear mechanism to the motor shaft 111 of the starter motor 102. Therefore, impact force applied from the armature 115 to the rear bracket 106 could lead to deforming the rear bracket 106 plastically and lifting up the rear bracket 106 from the yoke 105.

Particularly, as shown in FIG. 5, when the rear bracket 106 is of outer type in which the set bolts 108 are located on the outer side of the yoke 105, bolt securing force applied to the outer circumferential portion of the rear bracket 106 makes the fitting section P of the yoke 105 and the rear bracket 106 a supporting point, thereby applying impact force to the rear bracket 106. Accordingly, compared with the rear bracket of inner type in which the set bolts 108 are located on the inner side of the yoke 105, the rear bracket 106 of outer type has a longer distance between the supporting point and the working point of impact force and further no bolt securing force is applied between the supporting point and the working point of impact force. Therefore, if “Kicking back” occurs, the central portion of the rear bracket 106 is easily lifted up due to impact force applied from the armature 115, and the improvement of this problem has been desired to be made.

An object of the present invention is to provide a starter including a rear bracket which is resistant to deformation due to impact force exerted by “Kicking back”.

### Means for Solving the Problems

The starter of the present invention having a motor comprises: a cylindrical yoke; a rear bracket mounted to an opening portion of the yoke; flange sections protruding outward from the outer circumferential portion of the rear bracket; and bolt members mounted to the flange sections and joining the yoke to the rear bracket, in which the bolt members are located on the outer side of the yoke, is characterized in that the central portion of the rear bracket is expanded toward the inner side of the motor compared with the outer circumferential portion thereof so that the inner side of the motor may become convex.

In the starter of the present invention, since the rear bracket is expanded at the central portion thereof toward the inner side of the motor, the influence of impact force is relaxed by the central portion displaced inward in advance even if the rear bracket is subjected to the impact due to “Kicking back”. Accordingly, in spite of the outer bolt type configuration thereof, the starter of the present invention can prevent the rear bracket from being lifted up due to “Kicking back”, thereby improving the durability and water resistance thereof.

In the starter, the rear bracket may be formed sphere-like with the outer circumferential portion as a base and with the central portion as an apex. Moreover, the rear bracket may be formed chevron-like at the portion thereof passing through the central portion and connecting the opposed regions of the outer circumferential portion with the opposed regions of the outer circumferential portion as a base and with the central portion as an apex. In this case, the opposed regions of the outer circumferential portion may be used as flange sections. Further, an arch-like formed impact relaxation section may be provided between the central portion and the outer circumferential portion, thereby further improving the impact relaxation effect, when there occurs a “Kicking back phenomenon”.

On the other hand, the starter of the present invention having a motor comprises: a cylindrical yoke; a rear bracket mounted to an opening portion of the yoke; flange sections protruding outward from the outer circumferential portion of the rear bracket; and bolt members mounted to the flange sections and joining the yoke to the rear bracket, in which the bolt members are located on the outer side of the yoke, is characterized in that the rear bracket has an impact relaxation section for relaxing the impact force applied to the rear bracket. In this case, an arch-like side wall portion may be formed between the outer circumferential portion and the central portion as the impact relaxation section.

In the starter of the present invention, since an impact relaxation section is provided between the central portion and the outer circumferential portion of the rear bracket, the influence of impact force is relaxed by this impact relaxation section even if the rear bracket is subjected to the impact due to “Kicking back”. Accordingly, in spite of the outer bolt type configuration thereof, the starter of the present invention can prevent the rear bracket from being lifted up due to “Kicking back”, thereby improving the durability and water resistance thereof.

### ADVANTAGES OF THE INVENTION

According to the starter of the present invention, in a starter configured to have a motor comprising: a rear bracket mounted to an opening portion of a cylindrical yoke; and bolt members mounted to the flange sections protruding outward from the outer circumferential portion of the rear bracket; and joining the yoke to the rear bracket, in which the bolt members are located on the outer side of the yoke, the central portion of the rear bracket is expanded toward the inner side of the motor compared with the outer circumferential portion thereof. As a result thereof, the influence of the impact force exerted to the rear bracket due to “Kicking back” can be relaxed. Accordingly, in spite of the outer bolt type configuration thereof, the starter of the present invention can prevent the rear bracket from being lifted up due to “Kicking back”, thereby enabling the durability and water resistance thereof to be improved.

### BRIEF DESCRIPTION OF THE DRAWINGS

FIG. 1 A partly sectional side view showing a configuration of a starter according to one embodiment of the present invention;

FIG. 2 A front view showing a rear bracket used in the starter of FIG. 1.

FIG. 3 A cross sectional view taken on line A-A of FIG. 2.

FIG. 4 An illustrative view showing a configuration of a conventional starter.

FIG. 5 An illustrative view showing a mounting structure of a rear bracket used in the starter of FIG. 4.

Explanation of Reference Symbols

| | |
|---|---|
| 1: | starter |
| 2: | motor section |
| 3: | gear section |
| 4: | magnet switch section |
| 5: | case section |
| 11: | electric motor |
| 12: | planetary gear mechanism |
| 13: | overrunning clutch |
| 14: | pinion |
| 15: | idle gear |
| 16: | ring gear |
| 21: | motor housing |
| 22: | armature |
| 23: | rear bracket |
| 23a: | flange |
| 23b: | bolt hole |
| 23c: | outer circumferential portion |
| 23d: | bearing section |
| 23e: | inner end portion |
| 23f: | side wall portion |
| 24: | gear cover |
| 25: | set bolt |
| 26: | permanent magnet |
| 27: | motor shaft |
| 31: | metal bearing |
| 32: | drive shaft |
| 33: | bearing section |
| 34: | metal bearing |
| 35: | commutator |
| 36: | commutator piece |
| 37: | brush holder |
| 38: | brush holding section |
| 39: | brush |
| 41: | conductive plate |
| 42: | switch section |
| 43: | switch plate |
| 44: | power source terminal |
| 45: | switch shaft |
| 46: | internal gear unit |
| 47: | drive plate unit |
| 48: | internal gear |
| 49: | metal bearing |
| 51: | planetary gear |
| 52: | base plate |
| 53: | support pin |
| 54: | metal bearing |
| 55: | sun gear |
| 56: | clutch outer |
| 56a: | boss section |
| 56b: | clutch section |
| 57: | clutch inner |
| 58: | roller |
| 59: | clutch spring |
| 61: | helical spline section |
| 62: | spline section |
| 63: | stopper |
| 64: | circlip |
| 65: | gear return spring |
| 66: | inner end wall |
| 67: | clutch stopper |
| 68: | clutch cover |
| 69: | clutch washer |
| 74: | shaft hole |
| 75: | spring holding section |
| 76: | pinion gear metal |
| 77: | secured section |
| 78: | movable section |
| 79: | case |
| 81: | coil |
| 82: | stationary iron core |
| 83: | movable iron core |
| 84: | gear plunger |
| 85: | bracket plate |
| 86: | plunger spring |
| 87: | slide bearing |
| 88: | metal bearing |
| 90: | switch return spring |
| 101: | starter |
| 102: | starter motor |
| 103: | pinion gear |
| 104: | ring gear |
| 105: | yoke |
| 106: | rear bracket |
| 107: | front bracket |
| 108: | set bolt |
| 109: | flange |
| 111: | motor shaft |
| 112: | bearing |
| 113: | commutator |
| 114: | stator core |
| 115: | armature |
| 116: | brush |
| P: | fitting section |

### BEST MODE FOR CARRYING OUT THE INVENTION

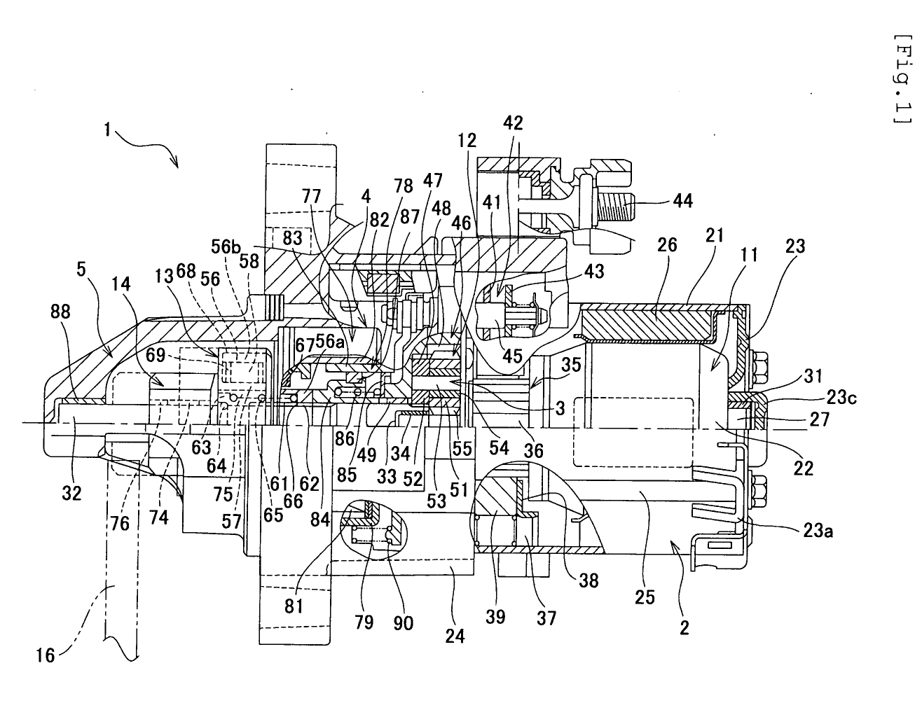

Now, embodiments of the present invention will be described in detail with referring to the accompanying drawings. FIG. 1 is a partly sectional side view showing a configuration of a starter according to one embodiment of the present invention. The starter 1 of FIG. 1 is used for starting an automotive engine and imparts rotations required for fuel intake, atomization, compression and ignition to an engine in a stop state.

Roughly speaking, the starter 1 comprises a motor section 2, a gear section 3, a magnet switch section 4, and a case section 5. In the motor section 2, there is provided an electric motor 11 (hereinafter, referred to as motor 11) as a driving source, and in the gear section 3, there are provided a planetary gear mechanism 12 as reduction gears, an overrunning clutch 13 and a pinion 14. The pinion 14 is mounted so as to be movable axially (in the left and right directions in the figure), and when moving in the left direction in the figure (hereinafter, the left and right direction will be based on FIG. 1 and the phrase “in the figure” will be omitted), the pinion 14 engages with a ring gear 16 of the engine. The torque of the motor 11 is transmitted to the pinion 14 via the planetary gear mechanism 12 and the overrunning clutch 13, and then, from the pinion 14 to the ring gear 16, starting the engine.

The motor 11 is configured to arrange an armature 22 rotatably within a cylindrical motor housing 21. The motor housing 21 acts also as the yoke of the motor 11 and is made of a magnetic metal such as iron. A metallic rear bracket 23 is mounted to the right end opening portion of the motor housing 21, and a gear cover 24 of the case section 5 is mounted to the left end opening portion of the motor housing 21. On the outer circumferential portion of the rear bracket 23, there are provided outward protruding flanges 23a, and bolt holes 23b are formed in the flanges 23a. Set bolts (bolt members) 25 are threaded through the bolt holes 23b. The set bolts 25 are screwed into bolt holes (not shown) provided in a gear cover 24 to be secured. The rear bracket 23 is joined to the motor housing 21 by the set bolts 25, and the motor housing 21 is secured between the rear bracket 23 and the gear cover 24.

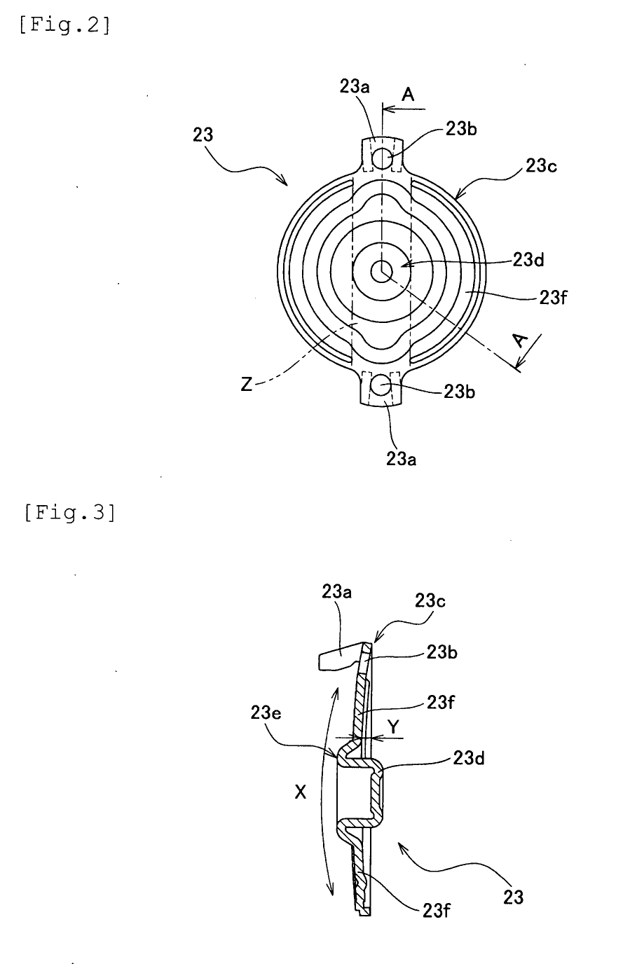

FIG. 2 is a front view showing a rear bracket 23, and FIG. 3 is a cross-sectional view taken along line A-A of FIG. 2. As described above, if “Kicking back” occurs, impact force is applied axially to the rear bracket 23 from the armature 22. In addition, since the starter 1 is of outer type in which the set bolts 25 are located on the outer side of the motor housing 21, there is a possibility that the rear bracket 23 is lifted up by the impact force applied to the central portion thereof. Therefore, in the present starter 1, the central portion of the rear bracket is expanded toward the inner side of the motor compared with the outer circumferential portion thereof in advance so that the inner side of the motor may become convex, thereby relaxing the influence of the impact force.

As shown in FIG. 3, the rear bracket 23 is formed so as to be curved sphere-like as shown by an arrow X as a whole with the outer circumferential portion 23c as a base and with the inner end portion 23e of a bearing section 23d located in the central portion thereof as an apex. In addition, in FIG. 3, the convex shape of the rear bracket 23 is shown exaggerated, and in the real rear bracket 23, the inner end portion 23e is expanded about 1 mm (dimension Y in the figure). When this rear bracket 23 is mounted to the end portion of the motor housing 21 and the set bolts 25 are tightened, the rear bracket 23 is assembled with the central portion thereof being slightly expanded inward.

In the starter 1 including this rear bracket, even if the rear bracket 23 is subjected to impact due to “Kicking back”, the internal stress of the inward expanded rear bracket 23 can relax this impact. Moreover, even if the rear bracket 23 is deformed due to this impact force, the deformation can be absorbed by the amount of the expansion displacement. That is, the rear bracket 23 has deformation margin against impact in advance, also thereby enabling the influence of the impact to “Kicking back” to be relaxed.

Further, when the rear bracket 23 is formed sphere-like (or chevron-like as described later), an arch-like side wall portion 23f is formed between the outer circumferential portion 23c and the bearing section 23d of the central portion. This side wall portion 23f has an effect of diffusing impact applied to the rear bracket 23, also thereby relaxing the impact at the time of “Kicking back”. In addition, the elastic deformation of the side wall portion 23f contributes to impact relaxation. That is, in the rear bracket 23, not only the expanded central portion thereof acts as an impact relaxation section, but also the side wall portion 23f acts as an impact relaxation section.

As described above, although configured as being of outer bolt type, the present starter 1 can prevent effectively the rear bracket 23 from being lifted up due to “Kicking back” by using a rear bracket 23 having a curved structure. If the rear bracket 23 is lifted up from the motor housing 21, there are dangers of dust and moisture coming in from the gap therebetween and of the tightening torque of the set bolts 25 being reduced. Therefore, when the rear bracket 23 is prevented from being lifted up by the configuration of the present invention, also the durability and water resistance of the starter 1 can be improved.

A plurality of permanent magnets 26 are secured to the inner circumferential surface of the motor housing 21 in a circumferential direction, and an armature 22 secured to a motor shaft 27 is provided inside each of the permanent magnets 26. The right end portion of the motor shaft 27 is supported rotatably by a metal bearing 31 mounted on the rear bracket 23. The left end portion of the motor shaft 27 is supported rotatably by an end portion of a drive shaft 32 to which the pinion 14 is mounted. In the right end portion of the drive shaft 32, a bearing section 33 is provided concavely, and the motor shaft 27 is supported rotatably by a metal bearing 34 mounted to the bearing section 33. In the armature 22, there is provided a commutator 35 secured to the motor shaft 27 with being fitted thereon. A plurality of commutator pieces 36 made of a conductive material are fitted to the outer circumferential surface of the commutator 35, and the end section of the armature coil (not shown) is secured to each of the commutator pieces 36. A brush holder 37 is mounted to the left end section of the motor housing 21. Brush holding sections 38 are arranged in the brush holder 37 with being spaced in a circumferential direction, and a brush 39 is contained in each brush holding section 38 so as to be able to appear freely. The projecting distal end (inner diameter side distal end) of the brush 39 is in sliding contact with the outer circumferential surface of the commutator 35.

The brush 39 is connected electrically to a conductive plate 41 provided on the brush holder 37. A switch section 42 is provided on the conductive plate 41, and when a switch plate 43 comes into contact with the conductive plate 41, an electric connection is made between a power source terminal 44 and the brushes 39, supplying electric power to the commutator 35. The switch plate 43 is mounted to a switch shaft 45, and when the magnet switch section 4 turns on electricity, the switch shaft 45 moves to the left to bring the switch plate 43 into contact with the conductive plate 41.

In the planetary gear mechanism 12 of the gear section 3, there are provided an internal gear unit 46 and a drive plate-unit 47. The internal gear unit 46 is secured to the right end side of the gear cover 24, and on the inner circumferential side thereof, an internal gear 48 is formed. A metal bearing 49 is contained in the center of the internal gear unit 46, supporting the right end side of the drive shaft 32 rotatably. The drive plate unit 47 is secured to the right end side of the drive shaft 32, and three planetary gears 51 are mounted with being equally spaced. The planetary gears 51 are supported rotatably by a support pin 53 secured to a base plate 52 via a metal bearing 54. The planetary gears 51 engage with the internal gear 48.

In the left end side of the motor shaft 27, a sun gear 55 is formed. The sun gear 55 engages with the planetary gears 51, and the planetary gears 51 rotate and revolute between the sun gear 55 and the internal gear 48. When the motor 11 is operated, the sun gear 55 rotates together with the motor shaft 27, and the rotations of the sun gear 55 are accompanied by the revolutions of the planetary gears 51 around the sun gear 55 with the planetary gears 51 engaging with the internal gear 48. Thereby, the base plate 52 secured to the drive shaft 32 is rotated, transmitting the decelerated rotations of the motor shaft 27 to the drive shaft 32.

The overrunning clutch 13 transmits the rotations decelerated by the planetary gear mechanism 12 to the pinion 14 in one rotation direction. The overrunning clutch 13 is configured to arrange a roller (not shown) and a clutch spring (not shown) between a clutch outer 56 and a clutch inner 57. The clutch outer 56 comprises a boss section 56a and a clutch section 56b, and the boss section 56a is mounted to a helical spline section 61 of the drive shaft 32. On the inner circumferential side of the boss section 56a, there is formed a spline section 62 engaging with the helical spline section 61, the clutch outer 56 is made movable axially on the drive shaft 32 along the helical spline section 61.

A stopper 63 is mounted to the drive shaft 32. The stopper 63 is hindered to move axially by a circlip 64 fitted to the drive shaft 32. One end side of a gear return spring 65 is attached to the stopper 63. The other end side of the gear return spring 65 is in contact with the inner end wall 66 of the boss section 56a. The clutch outer 56 is pushed to the right by this gear return spring 65, and at normal times (at the time of no power distribution), the clutch outer 56 is held with being in contact with a clutch stopper 67 secured to the gear cover 24.

On the inner circumference of the clutch section 56b of the clutch outer 56, there is provided a clutch inner 57 formed integrally with the pinion 14. A plurality of pairs of rollers 58 and clutch springs (not shown) are arranged between the clutch outer 56 and clutch inner 57. In addition, on the outer circumference of the clutch section 56b, a clutch cover 68 is provided, and a clutch washer 69 is fitted between the left end surface of the clutch section 56b and the clutch cover 68. By this clutch washer 69, the roller 58 and the clutch spring are contained on the inner circumferential side of the clutch section 56b with being hindered to move axially.

The inner circumferential wall of the clutch section 56b is formed as a cam surface including a cuneiform slope section and a curved section. The roller 58 is usually pushed by the clutch spring toward the curved section side. When the clutch outer 56 rotates and the roller 58 is interposed between the cuneiform slope section and the outer circumferential surface of the clutch inner 57 against the pushing force of the clutch spring 59, the clutch inner 57 rotates together with the clutch outer 56 via the roller 58. Thereby, when the motor 11 is operated and the drive shaft 32 rotates, the rotations thereof are transmitted from the clutch outer 56 via the roller 58 to the clutch inner 57, rotating the pinion 14.

On the contrary, when the engine is started and the clutch inner 57 rotates faster than the clutch outer 56, the roller 58 moves to the curved section side, bringing the clutch inner 57 into an idle running state to the clutch outer 56. That is, when the clutch inner 57 comes into an overrunning state, the roller 58 is not interposed between the cuneiform slope section and the outer circumferential surface of the clutch inner 57 and the rotations of the clutch inner 57 are not transmitted to the clutch outer 56. Accordingly, even if the clutch inner 57 is rotated faster from the engine side after the engine start, the rotations thereof are interrupted by the overrunning clutch 13 and are not transmitted to the motor 11 side.

The pinion 14 is a steel member formed by cold forging and is formed integrally with the clutch inner 57. On the inner circumferential side of the pinion 14, there are formed a shaft hole 74 and a spring holding section 75. In the shaft hole 74, a pinion gear metal 76 is fitted, and the pinion 14 is supported rotatably by the drive shaft 32 via a pinion gear metal 76. The spring holding section 75 is formed on the inner circumferential side of the clutch inner 57, and a stopper 63 and a gear return spring 65 are held therein.

The magnet switch section 4 is arranged concentrically with the motor 11 and the planetary gear mechanism 12 on the left side of the planetary gear mechanism 12. The magnet switch section 4 comprises a steel secured section 77 secured to the gear cover 24 and a movable section 78 arranged movably in the left and right directions along the drive shaft 32. In the secured section 77, there are provided a case 79 secured to the gear cover 24, a coil 81 held in a case 79 and a not shown stationary iron core 82 mounted to the inner circumferential side of the case 79. In the movable section 78, there is provided a movable iron core 83 to which the switch shaft 45 is mounted, and on the inner circumferential side of the movable iron core 83, a gear plunger 84 is mounted. On the outer circumferential side (lower end side in the figure) of the movable iron core 83, a switch return spring 90 is fitted. The other end side of the switch return spring 90 is in contact with the gear cover 24, and the movable iron core 83 is pushed to the right.

To inner circumference of the movable iron core 83, a bracket plate 85 is secured further. One end of a plunger spring 86 is secured to the bracket plate 85 by caulking. When the ignition key switch is turned OFF (in the state of FIG. 1), the other end of the plunger spring 86 contacts with a gear plunger 84, and the gear plunger 84 is pushed by the plunger spring 86 to the left. The gear plunger 84 is mounted axially movably to the drive shaft 32, and a slide bearing 87 is provided between the gear plunger 84 and the inner circumferential surface of the movable iron core 83.

The case section 5 is provided with the aluminum die-cast gear cover 24, and the left end side of the drive shaft 32 is supported rotatably by the gear cover 24 via a metal bearing 88. Within the gear cover 24, as described above, the synthetic resin (for example, glass-fiber-reinforced polyamide) clutch stopper 67 and the case 79 are secured, and to the right end side thereof, the motor housing 21 and the end cover 23 are secured by the set bolt 25.

Now, the starting operation of an engine using such an electric starter motor 1 will be described. First, as shown in FIG. 1, when the ignition key switch of a car is turned OFF, the clutch outer 56 contacts with the clutch stopper 67 by the pushing force of the gear return spring 65. At this time, the switch plate 43 is spaced from the conductive plate 41, supplying no current to the motor 11. Further, the idle gear 15 is in the disengagement position on the right and is disengaged from the ring gear 16.

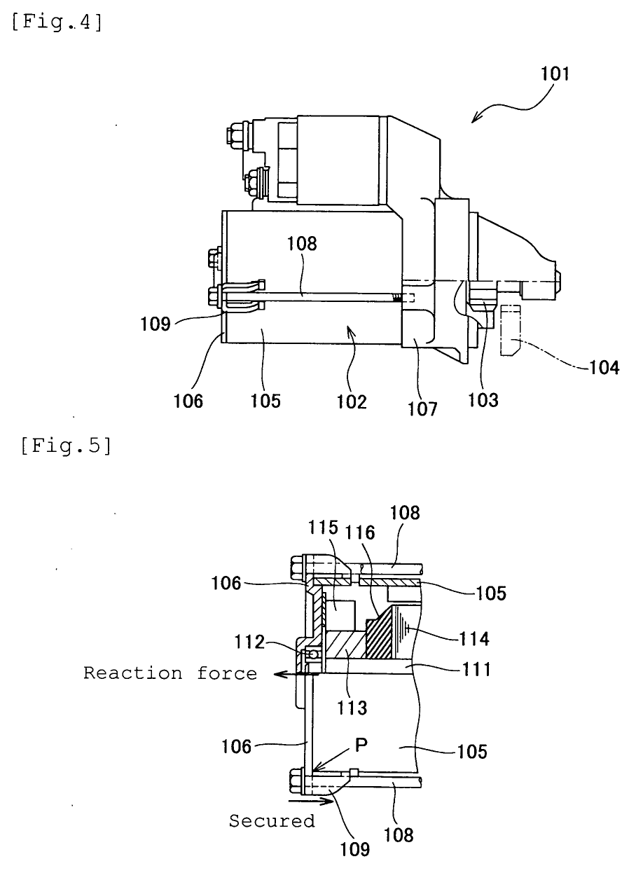

On the other hand, as shown in FIG. 4, when the ignition key switch is turned ON, the idle gear 15 moves to the left, engaging with the ring gear 16. That is, when the ignition key switch is turned ON, current flows first to the coil 81, creating suction at the magnet switch section 4. When the coil 81 is excited, a magnetic path extending through the case 79 and the stationary iron core 82 is formed, sucking the movable iron core 83 to the left. When the movable iron core 83 moves to the left against the pushing force of the switch return spring 90, the switch shaft 45 moves also to the left, bringing the switch plate 43 into contact with the conductive plate 41 to close a contact. Thereby, an electric connection is made between the power source terminal 44 and the brush 39, supplying power to the commutator 35 to start the motor 11 and rotate the armature 22. In addition, the bracket plate 85 moves also to the left, thereby compressing the plunger spring 86.

When the armature 22 is rotated, the drive shaft 32 is rotated via the planetary gear mechanism 12. The rotations of the drive shaft 32 are accompanied by the rotations of the clutch outer 56 mounted to the helical spline section 61. The twisting direction of the helical spline section 61 is set in consideration of the rotation direction of the drive shaft 32. As the clutch outer 56 rotates faster, the clutch outer 56 moves to the left along the helical spline section 61 (rest position→operation position) due to the inertial mass thereof. When the clutch outer 56 protrudes to the left, the pinion 14 also moves to the left together with the clutch outer 56 and it engages with the ring gear 16. At this time, also the gear return spring 65 is compressed by being pushed by the clutch outer 56.

When the idle gear 15 engages with the ring gear 16, the rotations of the motor 11 are transmitted to the ring gear 16, rotating the ring gear 16. The ring gear 16 is connected to a crankshaft of the engine. The rotations of the ring gear 16 are accompanied by the rotations of the crankshaft, starting the engine. When the engine is started, the pinion 14 is rotated with a high rotation speed by the ring gear 16 via the idle gear 15. However, the rotations thereof are not transmitted to the motor 11 side by the action of the overrunning clutch 13.

Further, when the clutch outer 56 moves to the left, the gear plunger 84 moves to the left by the pushing force of the compressed plunger spring 86, and then contacts with the right end surface of the clutch outer 56. At this time, the plunger spring 86 goes into a natural length state, creating a small gap between the gear plunger 84 contacting with the clutch outer 56 and the plunger spring 86.

When the engine is started, the pinion 14 is rotated with a high rotation speed, and the overrunning clutch 13 is rotated in an idle running direction. When the overrunning clutch 13 is rotated in the idle running direction, idle running torque is created in the clutch, applying torque called cutting torque to the clutch outer 56. This torque creates rightward thrust force in the clutch outer 56 via the helical spline section 61, moving the clutch outer 56 to the right. As a result, the pinion 14 may be disengaged from the ring gear 16. Thus, in the starter 1, the clutch outer 56 is held by the gear plunger 84 in the operated position, regulating the rightward movement of the pinion 14 to prevent it from being disengaged from the ring gear 16.

On the other hand, when the ignition key switch is turned OFF after the engine has been started, the power distribution to the magnet switch section 4 is stopped, and the suction thereof disappears. Then, the bracket plate 85 is pushed by the pushing force of a switch return spring 90 to the right, moving the movable iron core 83 held on the left by the suction of the stationary iron core 82 to the right. When the movable iron core 83 moves to the right, the switch shaft 45 also moves to the right, separating the switch plate 43 from the conductive plate 41 to open the contact. Thereby, the power supply to the motor 11 is shut off, stopping the rotations of the drive shaft 32 to stop also the rotations of the clutch outer 56.

When the rotations of the clutch outer 56 are stopped, also the axial moving force due to the inertial mass thereof disappears. Thus, by the pushing force of the compressed gear return spring 65, the clutch outer 56 moves to the right from the operated position to the rest position along the helical spline section 61. At this time, the gear plunger 84 is also pushed by the clutch outer 56 and returns to the state of FIG. 1. In addition, the pushing force of the gear return spring 65 is set to be greater than that of the plunger spring 86 at that time. When the clutch outer 56 moves to the right, the pinion 14 also moves to the right and it disengages from the ring gear 16.

The present invention is not limited to the embodiment described above, and it goes without saying that various changes can be made without departing the spirit of the present invention.

For example, in the embodiment described above, there is shown an example in which the rear bracket 23 is formed bowl-like. However, shown by a two-dot chain line in FIG. 2, the portion (reference symbol Z portion) passing through the central portion of the rear bracket 23 and connecting the opposed regions of the outer circumferential portion may be formed chevron-like with the opposed regions of the outer circumferential portion (for example, both flanges 23a) as a base and with the motor inner side end portion 23e of the bearing section 23d as an apex, and the bearing section 23d subjected to impact force may be displaced inward. Moreover, in the embodiment described above, there is shown a starter configured to mount an overrunning clutch 13 to a drive shaft 32 rotated by a motor 11 via planetary gear mechanism 12. However, the present invention is also applicable to various types of starters configured to have a motor having a rear bracket, such as a starter configured to mount an overrunning clutch to the distal end of a motor shaft 27.

In addition, in order to prevent the rear bracket 23 from being lifted up, there may be provided a lift-up prevention member as an impact relaxation section on the outside of the rear bracket 23. Such a lift-up prevention member includes, for example, a band plate bridging a gap between both flanges 23a and coming into contact with the bearing section 23d to suppress the central portion of the rear bracket to be deformed. However, as described above, a method of forming the rear bracket 23 convex reduces parts in number and is more cost-effective.

1. A starter having a motor comprising:
a cylindrical yoke; a rear bracket mounted to an opening portion of the yoke; flange sections protruding outward from the outer circumferential portion of the rear bracket; and bolt members mounted to the flange sections and joining the yoke to the rear bracket, in which the bolt members are located on the outer side of the yoke, characterized in that
the central portion of the rear bracket is expanded toward the inner side of the motor compared with the outer circumferential portion thereof so that the inner side of the motor may become convex.

2. The starter according to claim 1, characterized in that
the rear bracket is formed sphere-like with the outer circumferential portion as a base and with the central portion as an apex.

3. The starter according to claim 1, characterized in that
the rear bracket may be formed chevron-like at the portion thereof passing through the central portion and connecting the opposed regions of the outer circumferential portion with the opposed regions of the outer circumferential portion as a base and with the central portion as an apex.

4. The starter according to claim 1, characterized in that
an arch-like formed impact relaxation section is provided between the central portion and the outer circumferential portion.

5. A starter having a motor comprising: a cylindrical yoke; a rear bracket mounted to an opening portion of the yoke; a flange section protruding outward from the outer circumferential portion of the rear bracket; and bolt members mounted to the flange sections and joining the yoke to the rear bracket, in which the bolt members are located on the outer side of the yoke, characterized in that
the impact relaxation section for relaxing the impact force applied to the rear bracket is provided between the central portion and the outer circumferential portion.

6. The starter according to claim 5, characterized in that
the impact relaxation section is an arch-like side wall portion formed between the outer circumferential portion and the central portion.
